(19) United States
(12) Patent Application Publication
(10) Pub. No.: US 2009/0302025 A1
(43) Pub. Date: Dec. 10, 2009

(54) TEMPERATURE SENSOR FOR AN ELECTRIC HEATING VESSEL

(75) Inventor: Raymond G. Corkin, New South Wales (AU)

Correspondence Address: SCHWEGMAN, LUNDBERG & WOESSNER, P.A., P.O. BOX 2938, MINNEAPOLIS, MN, 55402, US

(73) Assignee: Sunbeam Corporation Limited, Botany (AU)

(21) Appl. No.: 12/301,956

(22) PCT Filed: May 11, 2007
(86) PCT No.: PCT/AU07/00635

§ 371 Date: Jun. 4, 2009

(30) Foreign Application Priority Data
May 12, 2006 (AU) 2006902515

(51) Int. Cl. H05B 3/68; H01R 43/00

(52) U.S. Cl. 219/445.1; 219/448.11; 29/592.1

(57) ABSTRACT

A heating vessel is described that includes a contact plate having a contact surface configured to be in direct thermal communication with the contents located in a heating chamber of the vessel and a heat distribution plate in thermal communication with the contact plate. The heat distribution plate is configured to be remote from the contact plate in at least one region to define a thermally insulating zone. There is a heat source in thermal communication with the heat distribution plate and an electronic temperature sensor located in the thermally insulating zone, in thermal communication with the contact plate. The electronic temperature sensor is thermally insulated from the heat distribution plate by the thermally insulating zone. The measured temperature may be used to control the heating of the kettle to bring the contents lo the boil or to maintain the measured temperature within a specified range.

### FIELD OF THE INVENTION

The present invention relates to heating vessels and in particular to heating vessels that include temperature sensors for accurately detecting the temperature of the heating vessel's contents during operation.

### BACKGROUND OF THE INVENTION

Heating vessels (such as kettles, percolators, mocha makers, rice cookers, slow cookers and electric fry ware) are commonly used to prepare food and drinks. These heating vessels generally include an electric heating element which heats a contact plate via a heat distribution plate. The heating surface of the contact plate is in direct contact with the vessel's contents.

Normally the heating vessel has a temperature sensor to sense the temperature of the vessel's contents. The temperature detected is used to control the operation of the heating vessel. For instance, a kettle has a temperature sensor to detect when water in the kettle is boiling. In the case of a kettle, the temperature sensor is often a mechanical sensor such as a snap-action bimetallic actuator which turns the kettle off once the water has boiled.

Usually the temperature sensor is mounted to the heat distribution plate. This mounting location greatly reduces the accuracy of the temperature sensor. The temperature sensor senses the temperature of the heat distribution plate and does not directly sense the temperature of the vessel's contents. Because of this, discrepancies may arise between the measured temperature and the actual temperature of the contents. For a kettle, this may result in the kettle switching off before the water is actually boiling.

An inaccurate temperature sensor limits the potential functionality of the heating vessel. Since the temperature of the vessel's contents is not accurately sensed, only a limited range of functions controlled with reference to an approximate temperature reading are possible. For example, in the case of a kettle, it is only possible to stop the kettle boiling based on an approximate boiling point.

Reference to any background art in the specification is not an acknowledgement or any form of suggestion that this background art forms part of the common general knowledge in Australia or any other jurisdiction or that this background art could reasonably be expected to be ascertained, understood and regarded as relevant by a person skilled in the art.

### SUMMARY OF THE INVENTION

According to a first aspect of the invention there is provided a heating vessel for heating contents located in a heating chamber of the heating vessel, the heating vessel including a contact plate having a contact surface configured to be in direct thermal communication with the contents located In the heating chamber of the vessel; a heat distribution plate in thermal communication with the contact plate, the heat distribution plate being shaped so that the heat distribution plate is remote from the contact plate in at least one region to define a thermally insulating zone; a heat source in thermal communication with the heat distribution plate; and an electronic temperature sensor, located in the thermally insulating zone, in thermal communication with the contact plate, the electronic temperature sensor being thermally insulated from the heat distribution plate by the thermally insulating zone.

According to a second aspect of the invention there is provided a method for producing a heating vessel for heating contents located in a heating chamber of the heating vessel, the method including the steps of providing a contact plate with a contact surface configured to be in direct thermal communication with the contents located in the heating chamber of the vessel; attaching a heat distribution plate to an underside of the contact plate so that the heat distribution plate is in thermal communication with the non-contact surface of the contact plate; removing at least one portion of the heat distribution plate to shape the heat distribution plate so that the heat distribution plate is remote to the contact plate in at least one region to form a thermally insulating zone; providing a heat source in thermal communication with the heat distribution plate; and mounting an electronic temperature sensor in the thermally insulating zone, in direct thermal communication with the contact plate, the electronic temperature sensor being thermally insulated from the heat distribution plate by the thermally insulating zone.

According to a third aspect of the invention there is provided a heating vessel comprising a heating chamber for holding material to be heated; a heat source in thermal communication with the heating chamber; a temperature sensor that generates a temperature signal related to a temperature of the material in the heating chamber; a load sensor that generates a load signal related to a quantity of material held in the heating chamber; and a heat-source controller operable to control the heat source dependent on the load signal and the temperature signal.

According to a further aspect of the invention there is provided a method for controlling a heat source that heats material held In a heating chamber of a heating vessel, the method comprising the steps of generating a temperature signal related to the temperature of the material in the heating chamber; generating a load signal related to an amount of material held in the heating chamber; selecting a threshold value dependent on the load signal; and switching off the heat source if the temperature signal is greater than or equal to the selected threshold value.

### BRIEF DESCRIPTION OF THE DRAWINGS

Embodiments of the invention will now be described with reference to the drawings, in which:

FIG. 1 is a cross-sectional drawing of an electric kettle;

FIG. 2 is a partially cut-away view of a heater assembly for the kettle of FIG. 1;

FIG. 3 shows more detail of the heater assembly of FIG. 2 including an electronic temperature sensor and heat-source controller;

FIG. 4 shows a cross-sectional view of part of the heater assembly;

FIG. 5 shows an arrangement in which the heater assembly is positioned on a concave contact plate of the kettle;

FIG. 6 shows an arrangement in which the heater assembly is positioned on a convex contact plate of the kettle;

FIG. 7 shows a button arrangement for controlling ‘boil’ and ‘keep warm’ operating modes for the kettle, the button arrangement including indicators of the state of the kettle;

FIG. 8 is a graph illustrating the operation of the kettle in the boil mode;

FIG. 9 is a graph illustrating the operation of the kettle in the ‘keep warm’ mode;

FIG. 10 is a graph illustrating the effect of adding water to the kettle during the keep warm mode;

FIGS. 11 and 12 are graphs comparing the temperature of water in the kettle with the temperature measured by the temperature sensor of FIG. 2;

FIG. 13 is a graph comparing the performance of the kettle of FIGS. 1 to 7 with the performance of a standard kettle;

FIG. 14 shows a bottom view of an alternative heater assembly for use in the kettle of FIG. 1;

FIG. 15 shows a cross-sectional side view of the heater assembly of FIG. 14;

FIG. 16 shows a further view of the heater assembly of FIG. 14, illustrating the threaded mounting of a temperature sensor; and

FIG. 17 is a flow diagram illustrating a method of selecting the cut-off temperature dependent on the load in the kettle.

### DETAILED DESCRIPTION OF THE EMBODIMENTS

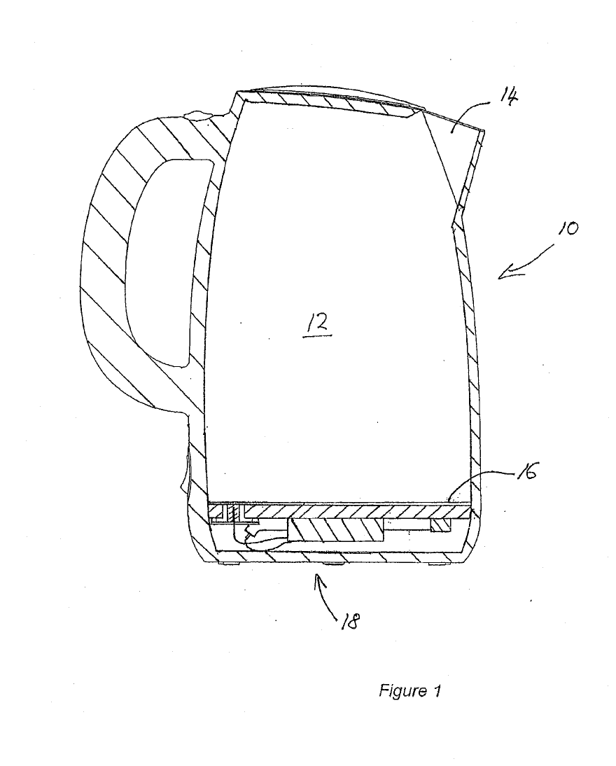

FIG. 1 shows a cross-sectional view of an electric kettle 10. The electric kettle has a heating chamber 12, which holds the water to be boiled. The water may be poured into the heating chamber 12 of the kettle through the pouring spout 14. The base wall of the heating chamber 12 is defined by a contact plate 16. Water stored in the heating chamber 12 is in direct contact with one side of the contact plate 16. The contact plate 16 may be formed from stainless steel. Other materials which are suitable for contacting water and are resistant to high temperatures and oxidation may be used.

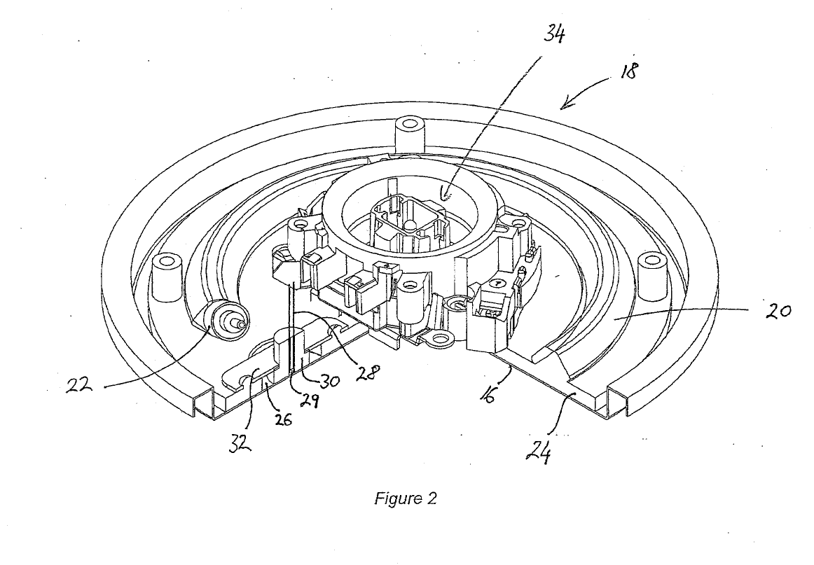

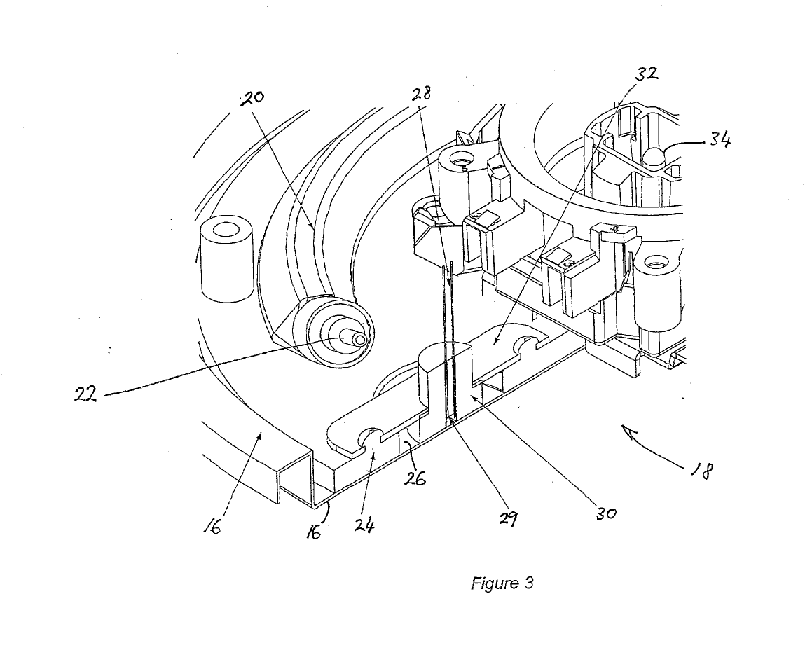

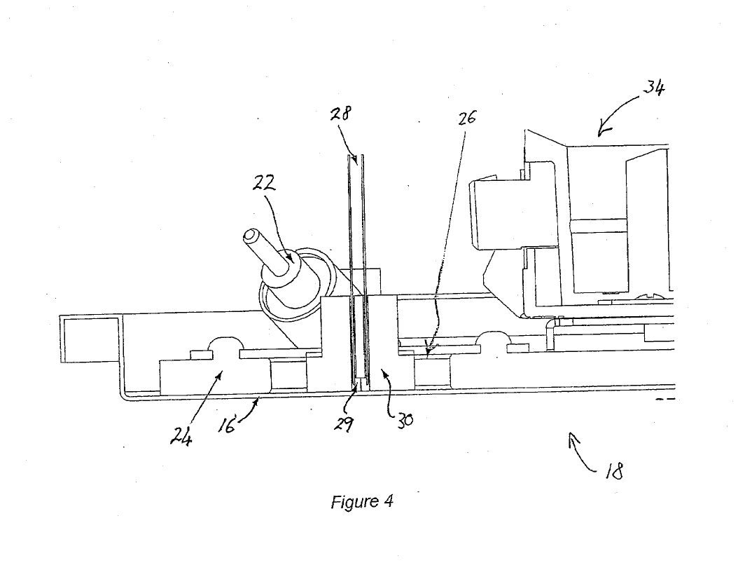

The contact plate 16 forms part of a heater assembly 18. The heater assembly is generally located underneath the heating chamber 12 on the opposite side of the contact plate to the heating chamber 12. One embodiment of the heater assembly 18 is shown in greater detail in FIGS. 2 to 4. The heater assembly 18 is powered by a power source (not shown) which is external to the kettle 10. The power may be transmitted to the heater assembly 18 using known techniques, for instance through a plug-in electrical lead.

The heat used to boil the water is generated by a heating element 20, which is curved and terminates in cold tails carrying electrical connections 22. Preferably the heating element 20 is powered by electricity. The heating element 20 shown is a resistance element. Other types of heating elements may be used.

The heating element 20 is bonded to a heat distribution plate 24. The bonding achieves a good thermal coupling between the heating element 20 and the heat distribution plate 24 so that heat generated by the heating element 20 is rapidly and efficiently transferred to the heat distribution plate 24. Many known bonding techniques are suitable, including induction welding, flame or oven welding and impact welding. Alternatively the heating element 20 may be mounted to the heat distribution plate 24 using other known techniques, such as mechanical fasteners.

The heat distribution plate 24 is induction brazed to the contact plate 16 so there is a good thermal coupling between the heat distribution plate 24 and the contact plate 16. Many other known bonding techniques are suitable, including the bonding techniques mentioned above. Alternatively the heat distribution plate 24 may be mounted to the contact plate 16 using other known techniques, such as mechanical fasteners.

The heat distribution plate 24 may be formed from aluminium, which is a good thermal conductor, and is of sufficient thickness so that heat is evenly distributed over the contact plate 16. Alternative materials for the heat distribution plate 24 include other metals and metal alloys. The heat distribution plate 24 is generally thicker than the contact plate and formed from a material which is a better thermal conductor than the contact plate.

The heat distribution plate 24 defines a void 26. The void 26 forms a thermally insulating zone. This is because heat which is transmitted from the heating element 20 to the heat distribution plate 24 is not as readily transmitted across the void 26. The region of the contact plate 16 located adjacent the void 26 does not conduct significant amounts of heat when compared to the aluminium heat distribution plate 24 because the contact plate 16 is thin and formed from stainless steel, which is not as good a thermal conductor.

Mounted in the void 26 is an electronic temperature sensor 28. The void 26 provides a thermally insulating zone around the electronic temperature sensor 28. Heat from the heat distribution plate 24 is not readily transmitted to the electronic temperature sensor 28. As a result, the electronic temperature sensor 28 is thermally insulated and is not undesirably influenced by the temperature of the heating element 20 and heat distribution plate 24.

Preferably the thermally insulating zone and the temperature sensor 28 are located between the cold tails 22 of the heating element 20. The cold tails do not generate significant amounts of heat, so the electronic temperature sensor 28 is further insulated from the heat generated by the heating element 20. Instead of being empty, the void 26 may be filled, either partially or wholly, with an insulating material, such as silicone or rubber.

The temperature sensor 28 is mounted in close proximity to the contact plate 16. Optionally, the temperature sensor 28 may be touching the contact plate 16, This improves the thermal coupling between the electronic temperature sensor 28 and the contact plate 16. The thermal coupling may be further improved using known techniques, such as applying a heat transfer paste.

It is an advantage that the temperature sensor 28 is in thermal contact with the contact plate 16 in the region indicated by 29. When water contained in the heating chamber 12 of the kettle 10 heats up, the contact plate 16 will heat to a similar temperature. Due to the void 26, the region of the contact plate 16 located within the void is insulated from the heat distribution plate 24 and will more accurately reflect the temperature of the water. Since the temperature sensor 28 is in thermal communication with the contact plate 16, it senses the water temperature with greater accuracy and responsiveness.

FIGS. 2 to 4 show the temperature sensor 28 being supported by a sensor support 30. The sensor support 30 is formed from silicone, and is held in place by a bracket 32. Other insulating materials are also suitable. The bracket 32 is mechanically fastened to the heat distribution plate 24 and is preferably formed from a relatively rigid material, such as a plastic, metal or metal alloy. The bracket 32 locates the sensor support 30 in the centre of the void 26 so the sensor 28 is insulated and may press the sensor support 30 against the contact plate 16, providing a good thermal connection between the sensor 28 and the contact plate 16. The temperature sensor 28 may be mounted in a number of ways which aim to minimise the influence of heat from the heat distribution plate 24.

The temperature sensor 28 is typically a thermistor. NTC thermistors formed from metal oxides are suitable. A thermistor has a number of advantages over other types of temperature sensors. A thermistor senses the temperature of water in the kettle within a continuous range. This provides significantly more information on the temperature of the water than, for example, a bimetallic actuator. A bimetallic actuator is typically activated only when the water reaches a threshold temperature value and is deactivated when the water falls below a threshold temperature value. As a result, a bimetallic actuator only senses whether the water temperature is above or below a threshold value. The thermistor provides responsive and accurate readings because it is mounted in a thermally insulating zone in direct thermal communication with the contact plate 16.

The heater assembly 18 shown in FIGS. 2 to 4 has a single void 26 in which the temperature sensor 28 is located, It is also possible to have multiple voids around the temperature sensor. Each void forms a thermally insulating region. By positioning a number of the thermally insulating regions around the sensor 28, a thermally insulating zone is formed. The sensor 28 is still mounted in direct thermal contact with the contact plate 16.

In one arrangement the contact plate 16 is indent-free. The contact plate 16 shown in FIGS. 2 to 4 is indent-free at least in the region of the temperature sensor 28. This shape may improve the accuracy of the temperature sensor 28. Because the contact plate 16 is indent free, water contained in the heating chamber 12 of the kettle 10 is able to readily and rapidly mix, This means the temperature of water located immediately above the temperature sensor 28 is more likely to accurately reflect the temperature of the remaining water volume contained in the kettle 10. Consequently the temperature sensor 28 gives more accurate readings of the temperature of all of the water in the kettle 10.

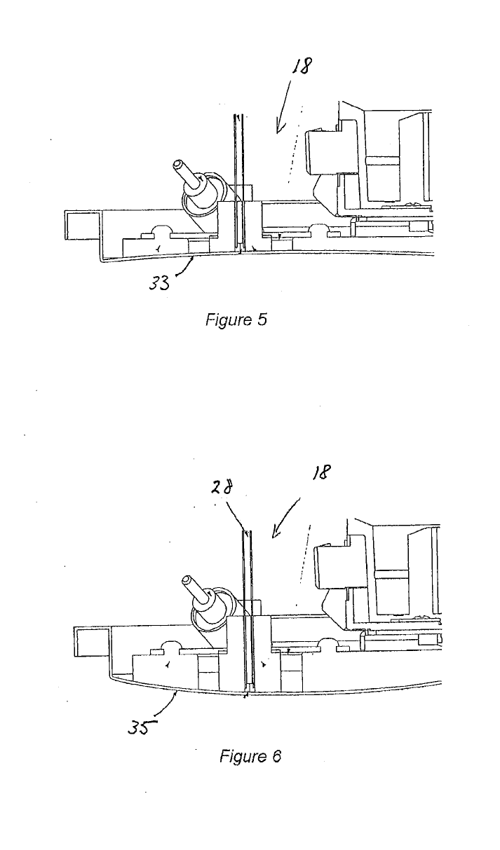

Alternative arrangements are shown in FIGS. 5 and 6, in which the contact plate is not uniplanar but is nevertheless free of indents in the region of the temperature sensor 28. FIG. 5 shows a concave contact plate 33 which is curved towards the heater assembly 18 in the centre of the contact plate. FIG. 6 shows a convex contact plate 35 which is curved away from the heater assembly 18 in the centre of the contact plate. In the case of FIG. 6, the convex curvature of the contact plate 16 results in the temperature sensor 28 protruding into the heating chamber 12 of the kettle 10 by a greater amount than other regions of the contact plate 16. Since the cold water tends to collect in the lower-most volumes of the heating chamber 12, water located opposite the sensor 28 is more likely to reflect the average temperature of the water contained in the kettle 10. This may improve the accuracy of temperature readings made by the sensor 28. In further arrangements (not illustrated) the contact plate 16 has a dome-shaped protrusion in the region adjacent the temperature sensor 28. The dome formed in the contact plate 16 may extend into the heating chamber 12 or, alternatively, may extend away from the heating chamber.

Referring again to FIGS. 2 to 4, the heater assembly 18 has a heat-source controller 34, The heat-source controller is electronically connected to the temperature sensor 28 and the heating element 20. The heat-source controller 34 controls the operation of the heating element 20 with reference to the temperature sensed by the temperature sensor 28. Preferably, the controller 34 consists of an electronic circuit or number of electronic circuits. These circuits may be designed in a number of ways to provide the functionality described below. The controller 34 preferably includes a microprocessor.

The heat-source controller may have a number of different functions, such as a boil function and a “keep warm” function, which use feedback from the temperature sensor 28. These functions are made possible because the temperature sensor 28 is able to accurately sense the temperature of the water contained in the kettle 10 within a large range. For example, the temperature sensor 28 may have an operating range between 0° C. and 100° C.

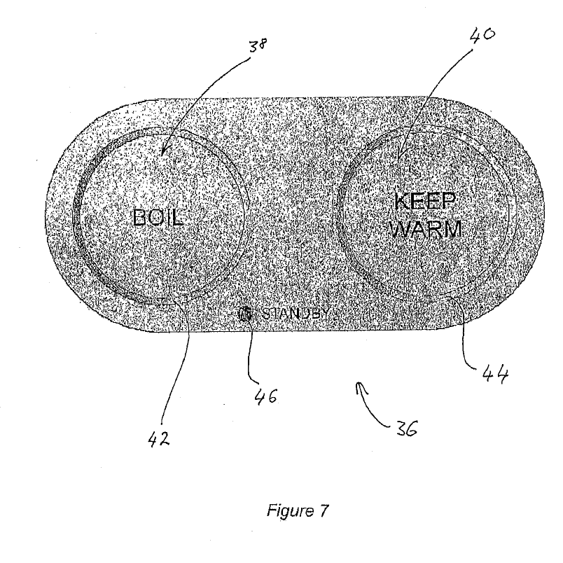

The functions of the kettle 10 are operated by button arrangement 36 which Is shown in FIG. 7. The button arrangement 36 consist of a “boil” button 38 and a “keep warm” button 40, both of which are momentary push buttons. The buttons 38, 40 may alternatively be a variety of other button types. A ring 42, 44 around each button is translucent. These rings are illuminated by LEDs to provide a user with information regarding the kettle's operation. The LEDs are optionally LEDs capable of emitting different coloured lights, for example to indicate temperature levels in the kettle. Other types of lights may be used, such as a conventional filament bulb. A “standby” LED 46 is illuminated when the external power is connected to the kettle. The buttons are connected to, and provide input to, the controller 34. The lights are connected to, and are operated by, the controller 34.

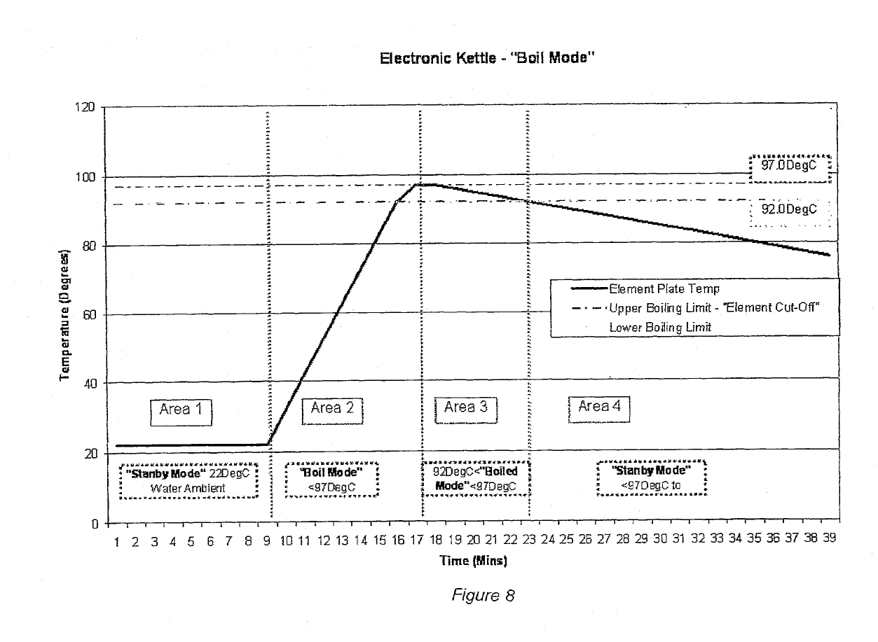

When the boil button 38 is activated, the controller 34 enters a boil mode, graphically displayed in FIG. 8. Before activation, the controller 34 is in a standby mode (indicated by “Area 1” in FIG. 8). After activation, the controller 34 enters the boil mode (indicated by “Area 2” in FIG. 8). When in the boil mode, the controller 34 turns on the heating element 20, which begins to heat the water in the kettle. The controller 34 additionally causes the illuminated ring 42 to produce, for example, red light, to indicate the controller is in the boil mode and the water is being boiled.

The temperature sensor 28 detects when an upper boiling limit has been reached. The upper boiling limit may be 97° C., though other limits are also suitable. At this point the controller enters a “boiled” mode (indicated by “Area 3” in FIG. 8). In the boiled mode, the controller turns off the heating element 20 and the red light in the illuminated ring 42. The controller then turns on, for example, a green light in the illuminated ring 42 to indicate that the water is boiled.

In the boiled mode, the temperature sensor 28 continues to sense the temperature of the water. After the heating element 20 is turned off, the water slowly cools. Once the temperature of the water falls to a lower boiling limit, the controller ends the “boiled” mode and returns to “standby” mode (indicated by “Area 4” in FIG. 8). At this stage, the controller turns off the green light in the illuminated ring 42 to indicate the water is no longer at or near boiling temperature. A suitable lower boiling limit is 92° C., though other limits are also suitable.

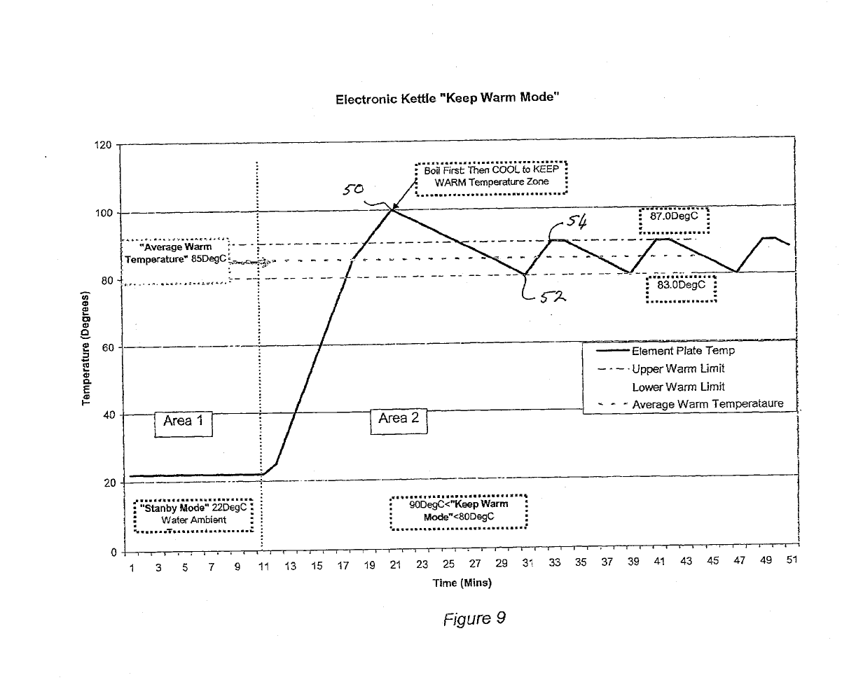

When the “keep warm” button 40 is activated, the controller 34 enters a keep warm mode in which the water is first boiled and then maintained at a warm average temperature, for example about 85° C. The keep warm mode is graphically illustrated in FIG. 9. Prior to activation, the controller is in the standby mode (indicated by “Area 1” in FIG. 9) and the water is at ambient temperature. In the keep warm mode (indicated by “Area 2” in FIG. 9), the controller 34 turns on the heating element 20. This heats the water as described previously. The controller 34 also causes a, for example, amber light to illuminate the illuminated ring 44 to indicate that the controller 34 is in the keep warm mode.

The heating element 20 continues to heat the water until the temperature sensor 28 detects the water temperature has reached an upper boiling limit, indicated at reference numeral 50. The heating element 20 is switched off and the water in the kettle cools gradually until a lower warm limit is reached, as indicated at reference numeral 52. A suitable lower warm limit is 83° C., although other values may be used. The controller 34 then switches the heating element 20 back on and the water temperature rises until an upper warm limit is reached (see reference numeral 54). A suitable upper warm limit is 87° C., though other limits are also suitable. When this occurs, the controller 34 turns off the heating element 20. This process continues so that the water temperature oscillates between the upper warm limit and the lower warm limit, keeping the water at an average temperature.

The keep warm mode continues until the keep warm button 40 is pressed to deactivate the keep warm mode. If the kettle is about to boil dry (that is, the water in the kettle has substantially evaporated), the temperature detected by the sensor 28 increases rapidly. If this rapid increase is detected, the controller 34 deactivates the keep warm mode and resumes the standby mode to avoid the kettle boiling dry. Alternatively, the keep warm mode may be ended automatically after four hours.

In one arrangement the kettle 10 may have two or more heating modes dependent on the load, i.e. the amount of liquid in the kettle. Low volumes of liquid heat up more rapidly than larger volumes. The controller 34 monitors the measured temperature and determines the rate of change of the measured temperature. The controller 34 selects a heating mode based on the rate of change. If low volumes are deduced (i.e. the rate of change of temperature lies in a specified higher range), then the heating element 20 is switched off at a reduced upper boiling limit. In the boil mode, a reduced upper boiling limit of 93° C. is suitable, although other values may be used.

If the controller 34 deduces that higher volumes of liquid are present (i.e. the rate of change of temperature lies in a specified lower range), the heating element 20 is switched off at a higher boiling limit, for example 97° C.

The controller 34 monitors the rate of change of measured temperature on a regular basis and, if necessary, selects a different upper boiling limit based on the current rate of change. Thus, for example, if cold water is added to the kettle 10, the controller 34 may need to switch to a heating mode that uses a higher cut-out temperature.

Two or more heating modes may be established. For the boil mode, the controller 34 may have a look-up table that lists a suitable upper boiling limit corresponding to different rates of heating. In one arrangement the lower boiling limit may also be reduced for the case of low volumes. For example, the lower boiling limit may be set 4° C. lower than the selected upper boiling limit.

In the keep warm operation, the controller 34 may also select a different upper boiling limit depending on the rate of change of temperature.

In alternative arrangements the load may be inferred from measurements other than the rate of change of temperature. Such alternative load measurements include the level of liquid in the kettle or the weight of the kettle. For example, a reed switch or capacitive sensor may be used to indicate the level in the kettle. In such an arrangement, the controller 34 may select a higher or lower boiling limit dependent on whether the level of fluid is above or below a threshold value.

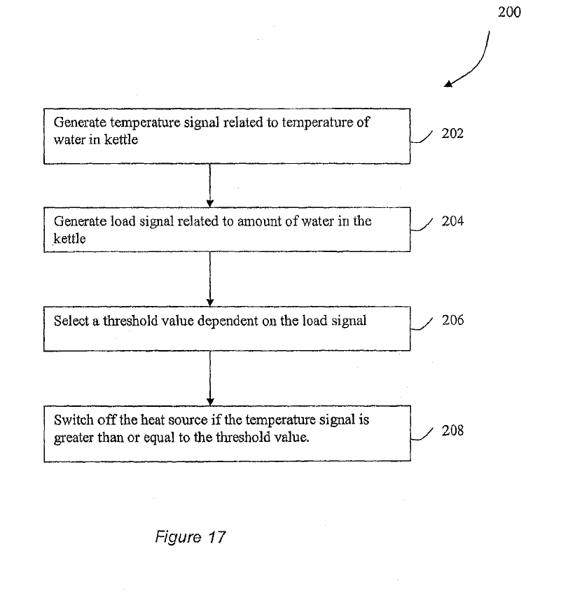

FIG. 17 Illustrates a method 200 of selecting the upper boiling limit. In step 202 the temperature sensor 28 generates a temperature signal that is related to the temperature of the water in the kettle 10. In step 204 a load signal is generated that is related to the amount of liquid in the kettle. In the preferred arrangement the controller 34 generates the load signal by monitoring the rate of change of the measured temperature, thereby deducing the load of the kettle. Based on the load signal, in step 206 the controller 34 selects a threshold value to use as the upper boiling limit. The threshold value may be read from a look-up table stored in memory. In step 208 the controller 34 acts to switch off the heating element 20 if the temperature signal is greater than or equal to the threshold value.

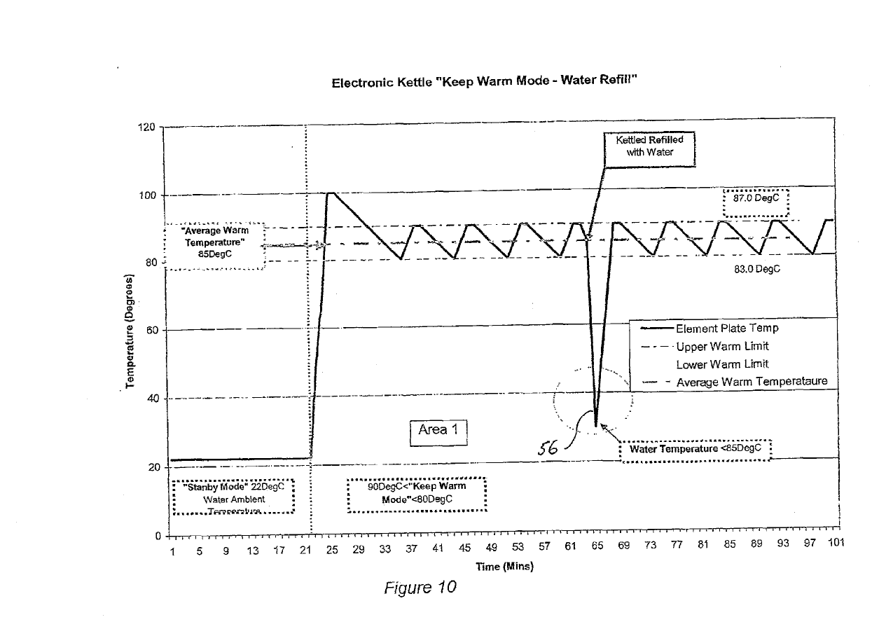

FIG. 10 shows the kettle 10 being refilled whilst the keep warm mode is activated. To refill the kettle, it may be disconnected from the external power supply. When this occurs, power to the controller 34 is disrupted. The controller 34 has an electronic memory which stores an indication of whether the controller is in the boil mode and/or the keep warm mode. The memory is preferably EPROM, though other types of memory may be used. Once the kettle is refilled, it is reconnected to the external power supply. The controller 34 then resumes the mode or modes which are stored in the memory.

When the kettle is refilled, the temperature of the water in the kettle drops rapidly, as indicated at reference numeral 56 in FIG. 10. When the controller 34 resumes the keep warm mode, the water is reheated until the upper warm limit is reached. The keep warm mode then continues as before. A similar process occurs if the kettle is refilled whilst in the boil mode.

The kettle may also have a audible indicator (not shown) for providing an audible indication of which mode the controller is in. The controller mode indicator may be one or more buzzers or speakers. The controller mode indicator is connected to, and operated by the controller 34.

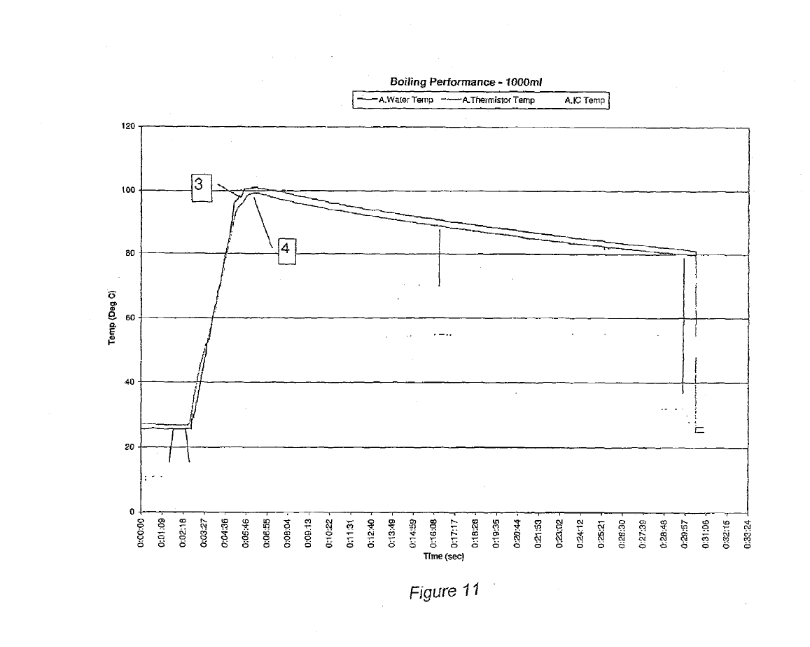

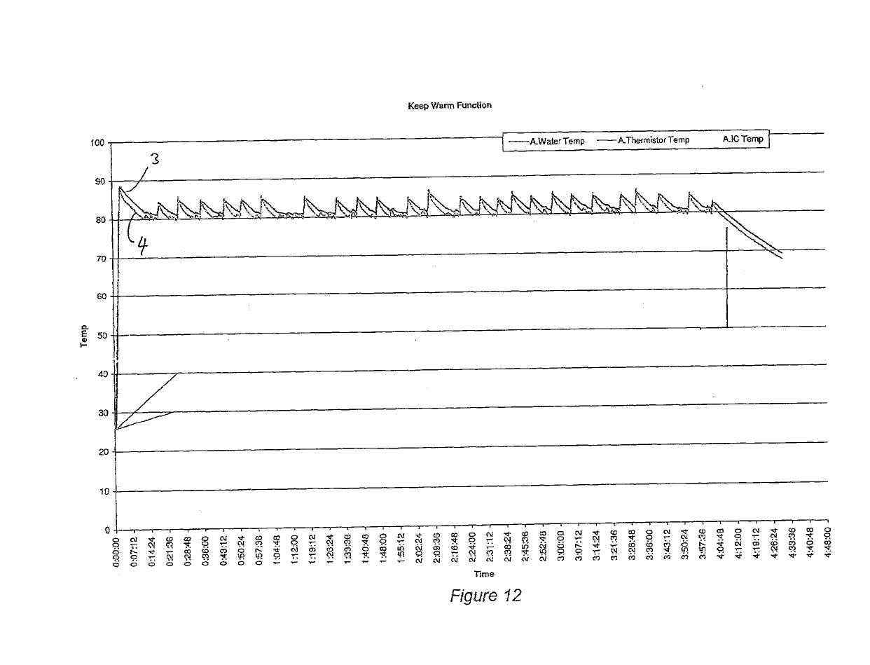

The additional functionality described above is made possible by the arrangements described herein. These arrangements provide a temperature sensor which Is able to accurately and responsively detect the temperature of water contained in the kettle. Without responsive and accurate temperature sensing, the boil mode and keep warm mode described above may not function properly. FIGS. 11 and 12 graphically show the accuracy and responsiveness of the temperature sensor. In these Figures, the darker line 3 represents the water temperatures and the line 4 represents the temperatures sensed by the temperatures sensor. As can be seen, the two lines are closely matched.

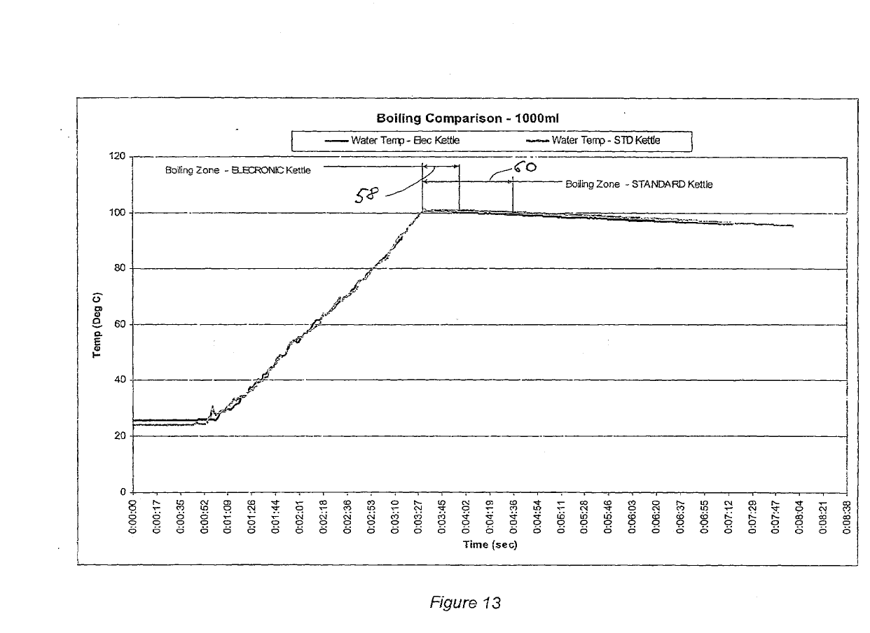

FIG. 13 shows a comparison between the temperature sensed during boiling by a temperature sensor in a conventional kettle (denoted “STD Kettle” in FIG. 13) and a temperature sensor in a kettle using the arrangements described herein (denoted “Elec Kettle” in FIG. 13). The same volume of water and heating power is used in each case. Once the water has boiled, each of the kettles switches off its respective heating element. However, the time between the water boiling and the heating element switching off is different in the two cases. As seen in FIG. 13, for a standard kettle the heating element stays on for a relatively long duration after the water boils, as indicated at reference numeral 60. In contrast, for the electronic kettle 10, the heating element 20 stays on for a shorter time, as indicated at reference numeral 58. With repeated use, this difference may represent a significant energy saving in the electric kettle 10 compared with the standard kettle. The improvement in performance is enabled by the greater accuracy of the temperature arrangement described herein compared with the bimetallic switch used in the standard kettle,

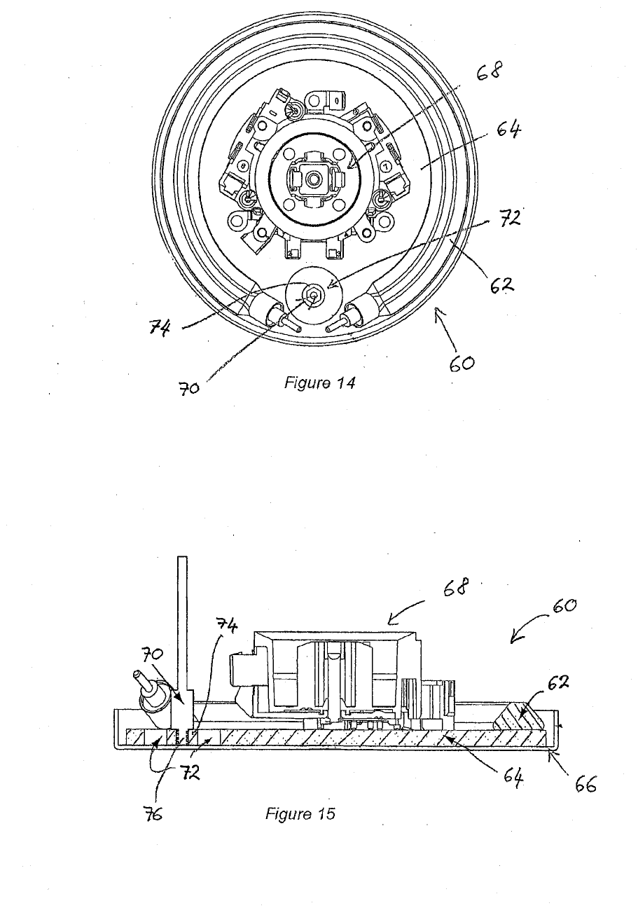

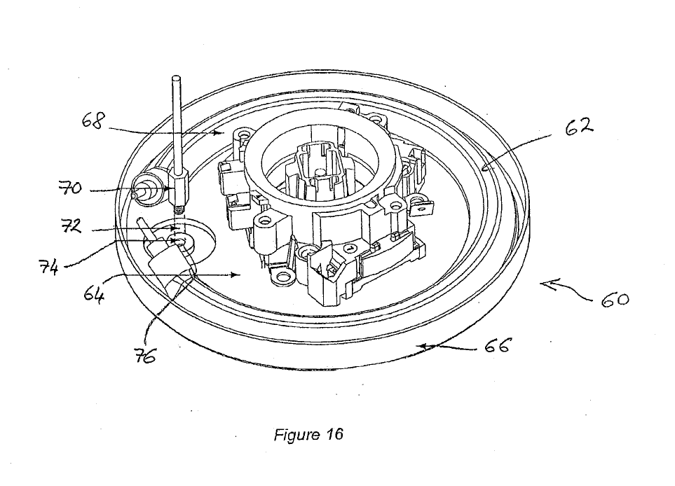

FIGS. 14 to 16 show an alternative heater assembly 60. The heater assembly 60 has a heating element 62, a heat distribution plate 64, a contact plate 66, a controller 68 and an electronic temperature sensor 70 which are similar in description and function to those described in relation to FIGS. 2 to 6.

The heat distribution plate 64 has a toroidal void 72. The void 72 forms a thermally insulating zone around the temperature sensor 70, for the reasons described above. The portion of the heat distribution plate located in the centre of the void 72 is a sensor mount 74 with a threaded aperture 76. The sensor is supported by an internally-threaded brass casing which screws into the aperture 76 so that the sensor is in direct thermal contact with the contact plate 64.

The heating assembly shown in FIGS. 2 to 4 may be produced by the following procedure. Firstly a heat distribution plate is induction welded to the underside of the contact plate. Other bonding methods described above may also be used, At this stage, the heat distribution plate need not have a void. A heating element is then bonded to the heat distribution plate. Any one of the bonding methods described above may be used.

If the heat distribution plate is not provided with a void, the void is formed by routing or milling away a region of the heat distribution plate to expose the contact plate underneath. The ease of manufacture is improved by forming the void after the heat distribution plate is bonded to the contact plate. The sensor is then mounted in the void in direct thermal communication with the exposed contact plate. Finally the controller is produced and mounted to the heat distribution plate.

The heater assembly shown in FIGS. 14 to 16 may be produced using a similar process. In this case, a toroidal void is formed in the heat distribution plate. The centre of the void is used as a sensor mount. A hole in the centre of the sensor mount is formed to allow the sensor to be in direct thermal communication with the contact plate and, optionally, to be in direct contact with the contact plate. The hole is tapped and the sensor is mounted by screwing a threaded sensor casing into the sensor mount.

Many alternative embodiments of the present invention are possible without departing from the principles of the present invention. For instance, the void may have any number of different shapes. Likewise, there can be a small portion of thermally conductive material (such as the brass casing) between the contact plate 64 and the sensor 70. Further, the heat distribution plate does not need to be in direct contact with the contact plate and the heating element does not need to be in direct contact with the heat distribution plate, so long as these components are in thermal communication with each other.

The principles of the present invention may be applied to other types of heating vessels, such as percolators, mocha makers, rice cookers, slow cookers and electric fry ware. In each case, the appliance has an electronic sensor which is insulated from a heating element by a thermally insulating zone and is in thermal contact (and possibly direct contact) with a contact plate. In the case of fry ware, the heating chamber is the pan.

It will be understood that the invention disclosed and defined in this specification extends to all alternative combinations of two or more of the individual features mentioned or evident from the text or drawings. All of these different combinations constitute various alternative aspects of the invention.

The term “comprises” (or its grammatical variants) is used in this specification as equivalent to the term “includes” and neither term should be taken as excluding the presence of other elements or features.

1-32. (canceled)

33. A heating vessel for heating contents located in a heating chamber of the heating vessel, the heating vessel including:
a contact plate having a contact surface configured to be in direct thermal communication with the contents located in the heating chamber of the vessel;
a heat distribution plate in thermal communication with the contact plate, the heat distribution plate being shaped so that the heat distribution plate is remote from the contact plate in at least one region to define a thermally insulating zone;
a heat source in thermal communication with the heat distribution plate; and
an electronic temperature sensor located in the thermally insulating zone, in thermal communication with the contact plate, the electronic temperature sensor being thermally insulated from the heat distribution plate by the thermally insulating zone.

34. A heating vessel as claimed in claim 33, in which the contact surface of the contact plate at least in the region of the temperature sensor is indent free.

35. A heating vessel as claimed in claim 33, in which the contact plate is shaped so that a region of the contact surface opposite the temperature sensor is configured to protrude further into the heating chamber of the vessel than another region of the contact surface.

36. A heating vessel as claimed in claim 33, in which the electronic temperature sensor is a thermistor.

37. A heating vessel as claimed in claim 33, which includes a sensor mount for mounting the electronic temperature sensor to the heat distribution plate.

38. A heating vessel as claimed in claim 37, in which the sensor mount is mounted to an underside of the contact plate generally opposite the contact surface.

39. A heating vessel as claimed in claim 37, in which the sensor mount includes a bracket mounted to the heat distribution plate.

40. A heating vessel as claimed in claim 37, in which the sensor mount is formed from a thermally insulating material.

41. A heating vessel as claimed in claim 33, in which the thermally insulating zone comprises at least one void.

42. A heating vessel as claimed in claim 33, in which the thermally insulating zone includes an insulating material.

43. A heating vessel as claimed in claim 33 which further includes a heat-source controller for controlling the heat source responsive to a temperature sensed by the temperature sensor.

44. A heating vessel as claimed in claim 43, in which:
the heat-source controller is operable to enter a boil state in which the heat-source controller controls the heat source to produce heat until the temperature sensor senses a stop boil temperature value; and
the heating vessel further includes an indicator configured to provide a boiled indication when the temperatures senses a temperature between the stop boil temperature value and a lower boil temperature value.

45. A heating vessel as claimed in claim 43, in which the heat-source controller is operable to enter a keep warm state in which the heat-source controller controls the heat source to produce heat so that the temperature sensed by the temperature sensor remains between an upper keep warm temperature value and a lower keep warm temperature value, the upper and lower keep warm temperature values being less than the stop boil temperature value.

46. A heating vessel as claimed in claim 45, in which:
the heater is powered by a power supply; and
the heat-source controller includes an electronic memory for, when power from the power supply is disrupted, storing whether the heat-source controller is in at least one of a boil state and a keep warm state; and
when power from the power supply is resumed, the heat-source controller is configured to resume the at least one state stored in the electronic memory.

47. A heating vessel as claimed in claim 42, in which the heat-source controller is configured to deactivate the heat source if a dry boil state is detected by the temperature sensor.

48. A heating vessel as claimed in claim 45, in which the heating vessel further includes a state display for displaying whether the heat-source controller is in at least one of the boil state and the keep warm state.

49. A heating vessel as claimed in claim 45, in which the heating vessel further includes an audio indicator for providing an audible indication when the heat-source controller enters at least one of the boil state, the keep warm state and a dry boil state.

50. A heating vessel as claimed in claim 43, wherein the heat source controller is operable to determine a rate of change of the temperature measured by the electronic temperature sensor.

51. A heating vessel as claimed in claim 50, wherein the heat-source controller is operable to select the stop boil temperature from a predefined set of stop boil temperatures, dependent on the determined rate of change of temperature.

52. A heating vessel as claimed in claim 33 wherein a thermal conductivity of the contact plate is less than a thermal conductivity of the heat distribution plate.

53. A heating vessel comprising:
a heating chamber for holding material to be heated;
a heat source in thermal communication with the heating chamber;
a temperature sensor that generates a temperature signal related to a temperature of the material in the heating chamber;
a load sensor that generates a load signal related to a quantity of material held in the heating chamber; and
a heat-source controller operable to control the heat source dependent on the load signal and the temperature signal.

54. A heating vessel as claimed in claim 53 wherein the load sensor generates the load signal dependent on a rate of change of the temperature signal.

55. A heating vessel as claimed in claim 53 wherein the heat-source controller switches off the heat source when the temperature signal reaches a threshold value, and wherein the heat-source controller selects the threshold value from a predetermined set of values, the selection being dependent on the load signal.

56. A heating vessel as claimed in claim 53 in which the heat-source controller is operable to enter a “keep warm” state in which the heat-source controller controls the heat source to produce heat so that the temperature sensed by the temperature sensor remains between an upper keep warm limit and a lower keep warm limit.

57. A method for producing a heating vessel for heating contents located in a heating chamber of the heating vessel, the method including:
providing a contact plate with a contact surface configured to be in direct thermal communication with the contents located in the heating chamber of the vessel;
attaching a heat distribution plate to an underside of the contact plate so that the heat distribution plate is in thermal communication with the non-contact surface of the contact plate;
removing at least one portion of the heat distribution plate to shape the heat distribution plate so that the heat distribution plate is remote to the contact plate in at least one region to form a thermally insulating zone;
providing a heat source in thermal communication with the heat distribution plate; and
mounting an electronic temperature sensor in the thermally insulating zone, in direct thermal communication with the contact plate, the electronic temperature sensor being thermally insulated from the heat distribution plate by the thermally insulating zone.

58. A method as claimed in claim 57, the method further including providing a heat-source controller for controlling the heat source responsive to the temperature sensed by the temperature sensor.

59. A method as claimed in claim 57, in which:
the at least one portion of the heat distribution plate removed is shaped to define at least one void and a sensor mount located in the at least one void, and the method further includes:
mounting the electronic temperature sensor to the sensor mount in direct thermal contact with the contact plate.

60. A method for controlling a heat source that heats material held in a heating chamber of a heating vessel, the method comprising:
generating a temperature signal related to the temperature of the material in the heating chamber;
generating a load signal related to an amount of material held in the heating chamber;
selecting a threshold value dependent on the load signal; and
switching off the heat source if the temperature signal is greater than or equal to the selected threshold value.

61. A method as claimed in claim 59 wherein the step of generating a load signal comprises:
switching on the heat source; and
measuring a rate of change of the temperature signal, wherein the load signal is dependent on the measured rate of change.

62. A method as claimed in claim 60 wherein the step of selecting a threshold value comprises reading the threshold value from a look-up table.
